(19) United States
(12) Patent Application Publication
(10) Pub. No.: US 2005/0115589 A1
(43) Pub. Date: Jun. 2, 2005

(54) Flotation device for brushes and combination thereof

(76) Inventors: Michael Perna, Mt. Prospect, IL (US); Nestor Hernandez, Bartlett, IL (US)

Correspondence Address: MERONI + MERONI, P.O. BOX 309, BARRINGTON, IL, 60011, US

(21) Appl. No.: 10/725,134

(22) Filed: Dec. 1, 2003

(51) Int. Cl. B08B 1/02; A46B 17/00

(52) U.S. Cl. 134/32; 15/246; 15/248.1; 15/143.1

(57) ABSTRACT

A flotation device for suspending bristles of a manual applicator brush in liquid having a foam body made of material resilient to chemical solvent degradation for flotation upon the liquid. The device has an aperture through the foam body sized and shaped for frictionally engaging a handle portion of the manual applicator brush during use. The aperture is positioned within the foam body to maintain substantial submersion of the bristles of the first manual applicator brush within the liquid. In another embodiment, the device has a plurality of different sized apertures through the foam body for receiving a plurality of manual applicator brushes.

### BACKGROUND OF THE INVENTION

1. Field of the Invention

The claimed invention generally relates to flotation devices. More specifically, the claimed invention relates to flotation devices for manual applicator brushes.

2. Description of the Prior Art

Paintbrushes and other manual applicator brushes have been used for many years without many significant changes for applying coatings such as paint and stain to surfaces. Paintbrushes have to be properly cleaned and/or stored after use so that the brushes may be used again at a later time. Devices have been conceived in the past to provide ways for cleaning and/or storing paintbrushes. However, the devices disclosed in the prior art have several drawbacks that limit the desirability of using these devices. Several of these devices are discussed here.

U.S. Pat. No. 6,050,408 issued to Testa discloses a paintbrush storage device. An alternate embodiment includes a pair of opposed protrusions molded into the side walls of the paint storage vessel and a corresponding pair of bumps located in the side walls of a modified paintbrush thereby causing the bristles to be fully suspended. The paintbrush storage device disclosed by Testa provides means for submersing the bristles of a paintbrush within liquid contained within the device, allowing the brush to be stored and reused without having to clean the brush between uses. However, there are undesirable consequences associated with using a device of this type. First, only one brush of a certain size and shape may be stored in a device of this type. Second, an amount of the coating being applied by the paintbrush must be poured into the device providing an additional chance to spill the coating. Finally, use of the device results in another implement to be cleaned before use of the device in a different coating application.

U.S. Pat. No. 5,992,617 issued to Couch discloses a storage device for paint rollers, paint roller covers, and paintbrushes. The paintbrush holder is a rectangular-shaped container having a foam insert fitted to its upper portion. The exterior of the insert is sized to fit the container. The insert has an opening for holding a paintbrush collar to allow the bristles to be in the container without touching the bottom. The insert keeps the brush wet and from drying out. Additionally, the invention encompasses devices to grip the handle of a paint implement so that it can be submerged in paint during storage. The paintbrush storage device disclosed by Couch provides means for storing a paintbrush between uses without having to clean the brush. However, there are undesirable consequences associated with using a device of this type as well. First, there must be enough liquid in the storage container to full immerse the bristles of the brush to prevent drying of the bristles. Further, the size and shape of the paintbrush holder limits use of the holder to containers having complementary size and shape.

U.S. Pat. No. 6,419,194 issued to LoSacco discloses a paintbrush holder having a pair of jaws for clamping to the side of a paint can. Complementary detents secure a clip member at varying altitudes. The paintbrush holder disclosed by LoSacco provides means for submersing bristles of a paintbrush in paint held in a paint container. However, a paintbrush holder of this type is limited in application. First, the parts are necessarily limited to fit one particular application; a paintbrush holder designed to be used with a one-gallon container may not be usable with a five-gallon container. Further, a holder of this type cannot be used while a container lid is being used to cover the container.

Due to the drawbacks of the prior art devices for use in cleaning and/or storing manual applicator brushes, there still remains a need for a device that will overcome many of the aforementioned shortcomings. The claimed invention provides a flotation device for suspending bristles of a manual applicator brush within a liquid and has several novel features that are unique to the subject matter. Flotation devices in general have been used for many years. However, as examples presented here show, the prior art does not disclose or suggest the novel features of the claimed device that provides an answer to the shortcomings of the prior art devices used in cleaning and/or storing manual applicator brushes.

U.S. Pat. No. 4,571,194 issued to Kiss discloses a flotation device for holding a beverage formed from an inflatable ring having a sheet secured to the center and a beverage holder secured in the center of the sheet. The flotation device disclosed by Kiss provides a float maintaining a desired item above the surface of the liquid on which the flotation device floats. However, flotation devices of this type do not teach or disclose many of the novel structural aspects presented in the claimed invention necessary to maintain submersion of a portion of an item being floated upon liquid.

U.S. Pat. No. 6,478,647 issued to Matthews discloses a personal flotation system. The system includes a plurality of flotation devices designed to individually support both the body and the head while the user is in the water. The flotation device disclosed by Matthews provide floats for maintaining the body above the surface of the water of a ring type design. However, the floats do not disclose or teach using the apertures through the rings to hold an item partially submerged within a liquid.

Therefore there is a need for a new device for cleaning and/or storing a manual applicator brush by means of flotation having novel aspects not previously disclosed in the flotation prior art. To fulfill this need, the claimed invention provides a flotation device for brushes.

### SUMMARY OF THE INVENTION

The claimed invention provides a flotation device for suspending bristles of a manual applicator brush in liquid on which the flotation device floats.

The primary objective of the claimed invention is to provide a flotation device for brushes that suspends bristles of a brush within liquid so that the bristles may be maintained in a useable condition between uses.

Another objective of the claimed invention is to provide a flotation device for brushes that provides means for passively cleaning brushes when the flotation device is used in conjunction with a cleansing liquid.

A further objective of the claimed invention is to provide a flotation device for brushes that provides multiple apertures for floating multiple brushes.

An even further objective of the claimed invention is to provide a flotation device for brushes that provides different sized apertures to receive brush handles of differing size.

To achieve these objectives, as well as others that will become apparent after reading this specification and viewing the appended drawings, a flotation device for brushes is provided. The device has a foam body made of material resilient to chemical solvent degradation. The foam body has top and bottom sides that are preferably substantially flat and are preferably substantially perpendicular with the side wall of the foam body.

An aperture is preferably centrally located within the foam body that is sized and shaped to frictionally engage the handle of a manual applicator brush during use. The aperture is positioned within the foam body to maintain substantial submersion of the brush bristles within the liquid during use.

In another embodiment of the claimed invention, the flotation device has a foam body for flotation upon liquid having a plurality of apertures through the foam body sized and shaped for frictionally engaging differing sized handle portions of manual applicator brushes. The apertures are positioned within the foam body to maintain substantial submersion of the bristles within the liquid with and without the engagement of additional manual applicator brushes during use.

### BRIEF DESCRIPTION OF THE DRAWINGS

FIG. 1. A side view of a brush engaged with the flotation device floating upon liquid within a liquid container.

FIG. 2. A perspective view of the flotation device engaged with a brush.

FIG. 3. A side view of a plurality of brushes engaged with another embodiment of the flotation device floating upon liquid within a liquid container.

FIG. 4. A perspective view of the flotation device shown in FIG. 3.

FIG. 5. A side view of a plurality of brushes engaged with a plurality of flotation devices shown in FIGS. 1 and 2 floating upon liquid within a liquid container.

FIG. 6. A perspective view of the arrangement of the flotation devices within the liquid container in FIG. 5.

### DETAILED DESCRIPTION OF THE PREFERRED EMBODIMENT

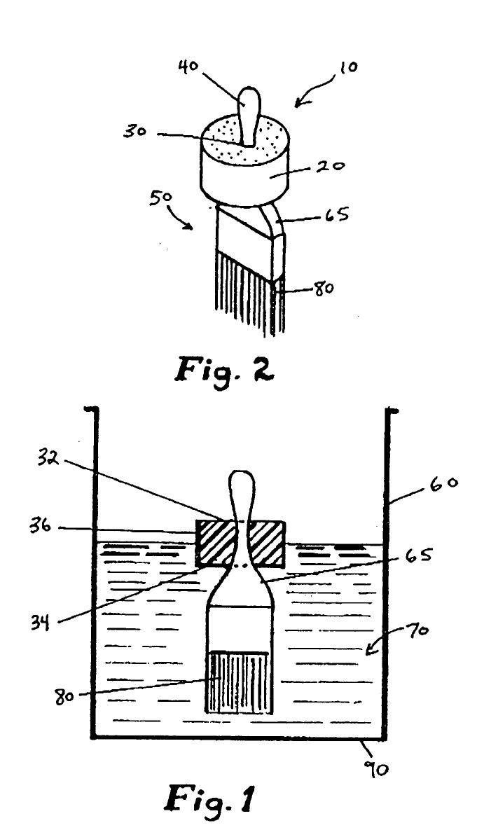

Turning now to the drawings, FIGS. 1 and 2 show the single brush embodiment of the flotation device 10 generally comprising a foam body 20 having an aperture 30 therethrough, a top side 32, a bottom side 34 and a side wall 36. The foam body 20 is preferably made of an engineered closed cell polyethylene foam that is resilient to chemical solvent degradation, such as NOMALOCK foam sold by Nomaco. Other similar types of closed cell polymer foam can be used to achieve the objectives of the claimed invention, however, NOMALOCK provided the best results during testing for corrosive resistance and buoyancy.

The flotation device 10 is used by frictionally engaging the handle 40 of a manual applicator brush 50 through the aperture 30 within the foam body 20 and then placing the flotation device engaged brush into an appropriate sized container 60 containing a predetermined amount of liquid 70. FIG. 1 shows a manual applicator brush 50 in the form of a typical house painting brush engaged with the flotation device 10 and floating upon liquid 70 contained within a five-gallon bucket 60. However, it should be understood that the novel aspects of the claimed invention could be applied in several other setting such as scaling the flotation device 10 to work in the context of brushes used to paint fine lines in works of fine art.

The flotation device 10 shown in FIGS. 1 and 2 is preferably approximately 3.5 inches in diameter and preferably approximately 2 inches in height. The aperture 30 is preferably ½ inch in diameter, although the diameter can be made as large as 11/16 inch for this type of application and still achieve the goals of the claimed invention. FIGS. 1 and 2 illustrate that the paintbrush 50 is typically engaged with the device 10 such that the shoulder portion of the brush 65 makes contact with the bottom side 34 of the device 10. When the paintbrush engaged device is placed in the container, the device has about a 1 inch draft, meaning that the device sinks about halfway into the liquid when engaged with a paintbrush.

The frictional engagement of the paintbrush handle 40 with the buoyant flotation device 10 as shown in FIG. 2 enables the bristles 80 of the paintbrush 50 to be suspended within the liquid 70 of the container 60 achieving several different goals. Primarily, the flotation device 10 helps maintain saturation of the bristles 80 preventing the bristles 80 from drying out and sticking together between uses.

The flotation device 10 also prevents disorientation of the bristles 80. Painters often place a relatively small amount of paint thinner in the bottom of a five-gallon bucket and then place paintbrushes in the bottom, resting the brushes upon the bristles so that the bristles come into contact with the paint thinner in order to clean the bristles of the brush between uses. It has come to our attention that this method of attempting to clean and store paintbrushes often results in deformation of the bristles from their original orientation. The flotation device 10 suspends the bristles 80 within the liquid 70 as shown in FIG. 1 preventing the bristles 80 from becoming disoriented due to the brush 50 resting on the bristles 80 against the bottom 90 of the bucket 60 for a long period of time.

The suspension of the bristles 80 within the liquid 70 also allows greater commingling of the liquid 70 with the bristles 80. When the brush 50 is simply placed upright against the bottom 90 of the container 60 as previously explained, the bristles 80 are usually not uniformly exposed to the liquid 70 resulting in possible clumping of bristles 80 making the brush 50 unusable. In contrast, the flotation device 10 allows more uniform exposure of the bristles 80 to the liquid 70 in the container 60.

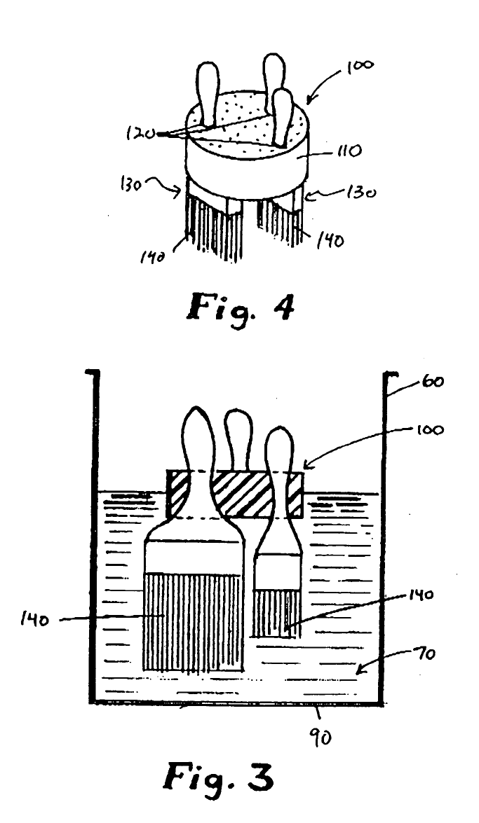

FIGS. 3 and 4 show another embodiment of the flotation device 100 where the foam body 110 has a plurality of apertures 120 through the body 110 to receive a plurality of brushes 130. The apertures 120 through the body 110 may be all of the same size and shape or may be of differing size and shape depending upon the intended application. FIG. 3 shows the flotation device 100 having apertures 120 of differing size and shape. In this embodiment of the invention, the foam body 110 has an oval shape with an outer diameter of about 3.5 inches and a height of about 2 inches. The apertures 120 are spaced within the body 110 of the flotation device 100 such that the flotation device 100 will maintain submersion of the bristles 140 within the liquid when the device 100 is used in conjunction with one or a plurality of paintbrushes during use.

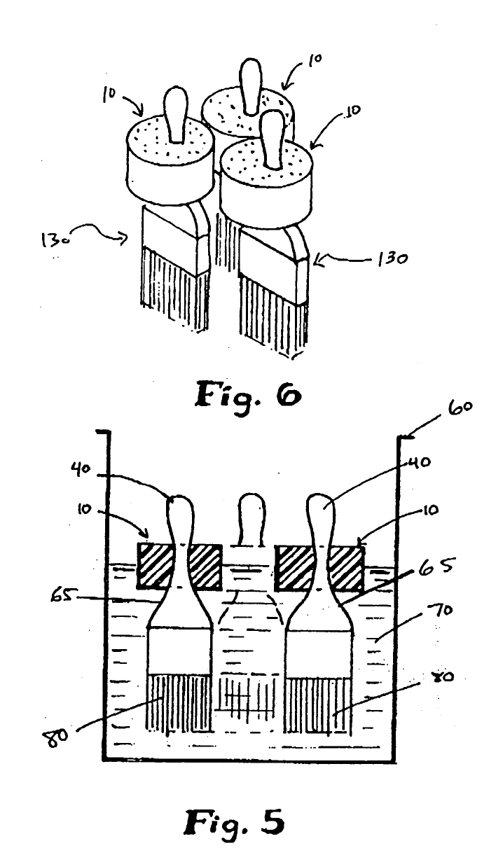

The flotation devices 10, 100 can also be used in a new method of cleaning manual applicator brushes. The inventor has found during testing of the flotation devices that agitating a five-gallon bucket partially filled with a cleaning agent such as paint thinner and having a paintbrush engaged with a flotation device inside creates a cleansing action against any coating material such as paint or varnish that may be adhered to the bristles of the brush. The inventor found this feature helpful in that paintbrushes could be passively cleaned when buckets containing paintbrushes as in FIG. 5 are placed in the back of a service vehicle such as a truck where the motion of the truck during driving agitates the paint thinner imparting a cleaning action on the bristles of the paintbrush. The relationship of the brushes during this method is shown in FIG. 6. During this method of cleaning paintbrushes, the flotation devices collide with one another and against the container walls causing movement of the bristles in relation to the paint thinner, increasing the interaction between the paint thinner and the bristles.

Although the invention has been described by reference to some embodiments it is not intended that the novel device be limited thereby, but that modifications thereof are intended to be included as falling within the broad scope and spirit of the foregoing disclosure, the following claims and the appended drawings.

1. A flotation device for manual applicator brushes in combination with a manual applicator brush, the combination comprising:
a manual applicator brush having a handle, a shoulder portion adjacent the handle and a plurality of bristles adjacent the shoulder portion; and
a foam body sized for flotation upon liquid within a portable container having an aperture through the foam body sized and shaped for frictional engagement with the handle of the manual applicator brush positioned within the foam body to maintain substantial submersion of the bristles within the liquid, the handle of the manual applicator brush engaged with the aperture and the shoulder portion of the manual applicator brush being seated against a floating side of the foam body such that the manual applicator brush is oriented in a substantially upright position.

2. The combination of claim 1 wherein the foam body is made of material resilient to chemical solvent degradation.

3. The combination of claim 2 wherein the aperture through the foam body has a diameter of from about 9/16 inches to about 11/16 inches.

4. The combination of claim 3 wherein the foam body has a thickness of from about 1 inch to about 3 inches.

5. The combination of claim 4 wherein the foam body has a width of from about 3 inches to about 5 inches.

6. A flotation device for suspending bristles of a first manual applicator brush in liquid having a foam body made of material resilient to chemical solvent degradation for flotation upon the liquid with a first aperture through the foam body sized and shaped for frictionally engaging a handle portion of the first manual applicator brush during use, the first aperture positioned within the foam body to maintain substantial submersion of the bristles of the first manual applicator brush within the liquid.

7. The flotation device of claim 6 further comprising a second aperture through the foam body having a diameter of a size differing from that of the first aperture, the second aperture frictionally engaging a handle portion of a second manual applicator brush during use, the second aperture positioned within the foam body to maintain substantial submersion of bristles of the second manual applicator brush with and without the presence of the first manual applicator brush during use.

8. The flotation device of claim 7 further comprising a third aperture through the foam body having a diameter of a size differing from that of the first aperture and second aperture, the third aperture frictionally engaging a handle portion of a third manual applicator brush during use, the third aperture positioned within the foam body to maintain substantial submersion of bristles of the third manual applicator brush with and without the presence of the first manual applicator brush and the second applicator brush during use.

9. The flotation device of claim 7 wherein the foam body has a thickness of from about 1 inch to about 3 inches.

10. The flotation device of claim 9 wherein the foam body has a width of from about 3 inches to about 5 inches.

11. A flotation device for suspending bristles of a manual applicator brush in liquid, the device comprising:
a foam body made of material resilient to chemical solvent degradation for flotation upon liquid, the foam body having a substantially flat top side, a substantially flat bottom side and at least one side wall perpendicular to the bottom side; and
a centrally located aperture through the foam body sized and shaped for frictionally engaging a handle portion of a manual applicator brush during use.

12. The device of claim 11 wherein the aperture through the foam body has a diameter of from about 9/16 inches to about 11/16 inches.

13. The device of claim 12 wherein the foam body has a thickness of from about 1 inch to about 3 inches.

14. The device of claim 13 wherein the foam body has a width of from about 3 inches to about 5 inches.

15. A method of cleaning manual applicator brushes, the method comprising:
filling an open mouthed container with cleansing fluid to a predetermined depth;
engaging a manual applicator brush with a flotation device made of material resilient to chemical solvent degradation having an aperture through the foam body sized and shaped for frictional engagement with a handle portion of the manual applicator brush;
floating the manual applicator brush engaged with the flotation device upon the cleansing fluid allowing bristles of the manual applicator brush to be suspended within the cleansing fluid;
allowing the cleansing fluid to cleanse the bristles of the manual applicator brush;
removing the manual applicator brush engaged with the flotation device from the container; and
disengaging the manual applicator brush from the flotation device.

16. The method of claim 15 further comprising agitating the container while the cleansing fluid is cleansing the bristles of the manual applicator brush.

17. The method of claim 15 further comprising allowing the bristles of the manual applicator brush to substantially dry.
